(19) United States
(12) Patent Application Publication
(10) Pub. No.: US 2001/0035497 A1
(43) Pub. Date: Nov. 1, 2001

(54) Detector support device for detecting ionizing radiations

(76) Inventors: Guillaume Montemont, Grenoble (FR); Marc Arques, Grenoble (FR); Loick Verger, Grenoble (FR)

Correspondence Address: PEARNE, GORDON, McCOY & GRANGER, 526 Superior Avenue East, Suite 1200, Cleveland, OH, 44114-1484, US

(21) Appl. No.: 09/834,538

(22) Filed: Apr. 13, 2001

(30) Foreign Application Priority Data
Apr. 27, 2000 (FR) 00 05390

(51) Int. Cl. G01T 1/24

(52) U.S. Cl. 250/370.01

(57) ABSTRACT

The invention relates to a device for detecting ionizing radiations comprising:

at least a detection component in semiconducting material (6), with upper and lower faces and a central portion and providing conversion of ionizing radiations into electric charges;

an upper electrode (4) and a lower electrode (5) positioned on the upper face and the lower face, respectively of the detection component, facing each other;

a support (1) wherein the detection component is positioned; and

electronic means (7) for polarizing the electrodes and reading out the signals delivered by said electrodes,

characterized in that the support includes walls (1a, 1b, 1d) in a conducting material forming at least an open compartment, surrounding the detection component (6) without any electrical contact with the central portion of said detection component.

### FIELD OF THE INVENTION

The invention is related to a detector support which may be used in devices of large dimensions for detecting ionizing radiations. This detector support is intended for associating several ionizing radiation detectors in order to form a detection linear array or a detection matrix.

The invention finds applications in the field of measurement and imaging of ionizing radiations such as gamma radiations. In particular, it finds applications in the field of gamma imaging, in order to enable 2D imagers of large dimensions to be built.

### STATE OF THE ART

Presently, imagers for ionizing radiations such as gamma radiations, are built by using detectors in semiconducting materials such as CdZnTe or CdTe, HgI₂, Ge, Si, etc. With such semiconductor detectors, when a photon, for example a gamma photon, arrives on the detector, it generates electron and hole pairs in a number proportional to its energy. These electrons are then collected by pairs of electrodes (anode/cathode) one placed on the upper face and the other on the lower face of the detector, these electrodes generating an electric field in the detector. An electrical signal, proportional to the energy deposited by the photon in the detector, is emitted by the detector and read by a readout electronic circuit.

However, these semiconductor detectors are of a small size and consequently, several of these detectors need to be assembled in order to build an imager, and in particular an imager of large dimensions. For this, the semiconductor detectors must be assembled as a matrix.

In order to enable semiconductor detectors to be assembled in a 2D matrix, U.S. Pat. No. 5,905,264 provides juxtaposition of modules for several pixels built on a single monolithic detector. In other words, a single block of detector material, called a detection component, supports several pairs of electrodes placed beside one another, wherein each pair of electrodes (anode/cathode) forms a pixel, the cathode may be common to several pixels. However, it is difficult to find a material which exhibits good charge transfer properties for a sufficiently large volume for containing n pixels.

Moreover, document “A Basic component for ISGRI, the CdTe gamma camera on board the INTEGRAL satellite”, ARQUES et al., IEEE Transactions on Nuclear Sciences 46(3): 181-186, 1999, provides a device built from several modules placed side by side, each containing a detector, each detector forming a pixel. Such a device has the advantage of providing high efficiency, because it is relatively easy to build good quality small size detectors. Furthermore, in this case, the technological processing of each pixel is relatively simple. However, assembly of these detectors on a same platform is complex, as this requires accurate mechanical positioning. Further, such a device suffers from the drawback that the closeness between the pixels generates a certain amount of electromagnetic crosstalk: displacement of charges caused by an interaction or noise in a detector is transmitted to the adjacent detectors capacitively.

The present ionizing radiation imagers further suffer from a drawback in the sense that the transport properties of the used materials (like CdZnTe) are modest and in particular, with regard to holes.

Generation of screen effects is suggested for compensating this poor hole transport property. The document “Electrode configuration and energy resolution in gamma-ray detectors” of LUKE, Nucl. Inst. Meth., A380: 232-237, 1996, as well as document “Performance of CdZnTe geometrically weighted semiconductor Frisch grid radiation detectors”, McGREGOR and ROJESKI, IEEE Nuclear Science Symposium, Nov. 8-14, 1998, and Patent Application WO-99 03155 provide devices for modifying the induction of the electric signal. In other words, in these devices, hole displacement is electromagnetically screened in order to measure only electron transport. However, these devices are complex and difficult to implement.

In particular, Patent Application WO-99 03155 provides a detector including a ring electrode positioned around the detection component and forming a Frisch grid, without any contact with the detection component and separated from it by a thickness of air or of another insulator.

However, these devices have the main drawback that they need a complex implementation, in particular the building of rings around the detector components. Further, these coating methods are not suitable for a collective treatment of several detectors and so an industrial application can hardly be contemplated.

### DESCRIPTION OF THE INVENTION

The object of the invention is precisely to find a remedy to the drawbacks of the devices described above. For this purpose, it provides a device for detecting ionizing radiations including a detector support or a partitioned support which provides proper and easy positioning of the detector while providing a shielding screen between the various detectors in order to prevent electromagnetic crosstalk problems, and enabling the electronic charges deposited by the incident radiation to be collected.

More specifically, the invention relates to a device for detecting ionizing radiations comprising:

at least a detection component in a semiconductor material, with upper and lower faces and a central portion, and providing conversion of ionizing radiations into electric charges;

an upper electrode and a lower electrode positioned on the upper face and lower face, respectively, of the detection component, facing one another;

a support wherein the detection component is positioned; and

electronic means for polarizing the electrodes and reading out the signals delivered by said electrodes,

characterized in that the support includes walls in a conducting material forming at least an open compartment, surrounding the detection component without any electrical contact with the central portion of said detection component.

According to an embodiment of the invention, the support is U-shaped.

Advantageously, the walls of the compartment are separated from the central portion of the detection component by an insulating material.

Each compartment forming the support may surround several detection components.

Advantageously, the support includes several compartments positioned one beside the other.

The walls of the support may be set to a fixed potential.

### SHORT DESCRIPTION OF THE FIGURES

FIGS. 1A and 1B schematically illustrate an embodiment of the detector support device of the invention;

FIGS. 2A and 2B illustrate another embodiment of the device of the invention; and

FIG. 3 illustrates the device of the invention, when it is associated with other identical devices.

### DETAILED DESCRIPTION OF THE EMBODIMENT OF THE INVENTION

The invention relates to a detector support device intended to be used in detectors of ionizing radiations, such as gamma rays. This detector support consists of a support called the detector support, having walls built in a conducting material or in an insulating material covered with a conducting layer, and surrounding the semiconducting detection material, called the “detection component”, however, without their being any electrical contact with this component.

This device may be built according to two embodiments.

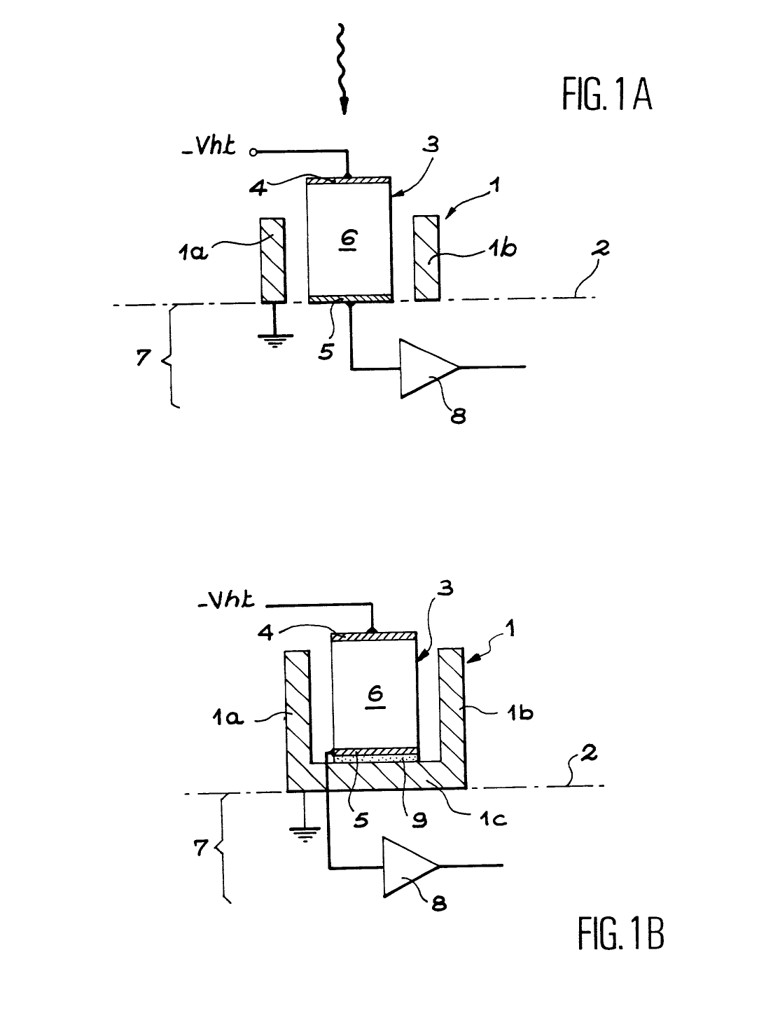

The first embodiment is illustrated in FIGS. 1A and 1B.

FIG. 1A shows detector 3 positioned on a platform 2 and surrounded by detector support 1. More specifically, detector 3 includes a detection component 6, made of a semiconducting material and having a parallelepipedal shape.

This detection component 6 includes an electrode 4 on its upper face and an electrode 5 on its lower face, facing each other.

The whole of this detector 3 lies on a platform 2 which forms the support of the polarization and readout electronic circuit, referenced as 7.

For example, this platform may be a printed circuit or else an alumina plate, etc . . .

The electronic circuit 7 has the role of polarizing the electrodes of the device on the one hand, and on the other hand, of reading out the electrical signals emitted by the electrodes. This electronic circuit 7 will be more precisely described later on.

Detector 3 is surrounded by the detector support 1. In the embodiment of FIG. 1A, the detector support 1 includes walls 1a and 1b, arranged so as to form an open compartment. This compartment is made of conducting material and has a larger surface than that of the detector 3. The latter is positioned at the center of the compartment on the one hand, so that the walls 1a et 1b of said compartment cannot be, under any circumstances, in electrical contact with the central portion of the detection component 6, i.e., with the non-covered semiconducting electrode portion of the detection component and, on the other hand, so that the height of the detector facing these walls extends from these electrodes.

The detector support may be built, for example, in aluminum or else in carbon or in any other machinable or moldable conducting material or even in an insulating material covered with a conducting material.

More specifically, the walls of the detector support 1 are insulated from the central portion of the detection component 6, either by air, or by an insulating material encapsulating said central portion.

These walls generate a shielding screen between two detectors, thereby preventing the electromagnetic crosstalk problems between the detectors.

The role of electrodes 4 and 5 is to generate an electric field in the detection component. For this purpose, the electrodes are polarized: electrode 4, i.e. the upper electrode, positioned on the upper face of the detection component 6, is set at a negative high voltage −Vht, and the lower electrode 5, i.e. the electrode placed under the lower face of detection component 6, is connected to the input of the readout circuit 8.

Thus, when incident radiation, such as a gamma ray (illustrated by a staggered arrow, in FIG. 1), arrives on detector 3, this radiation is transformed into electric charges by the semiconducting material. These charges are collected by the electrodes, and this generates an electrical signal which is read by the readout electronic circuit 8.

According to the embodiment illustrated in FIG. 1A, the readout circuit 8 is a preamplifier.

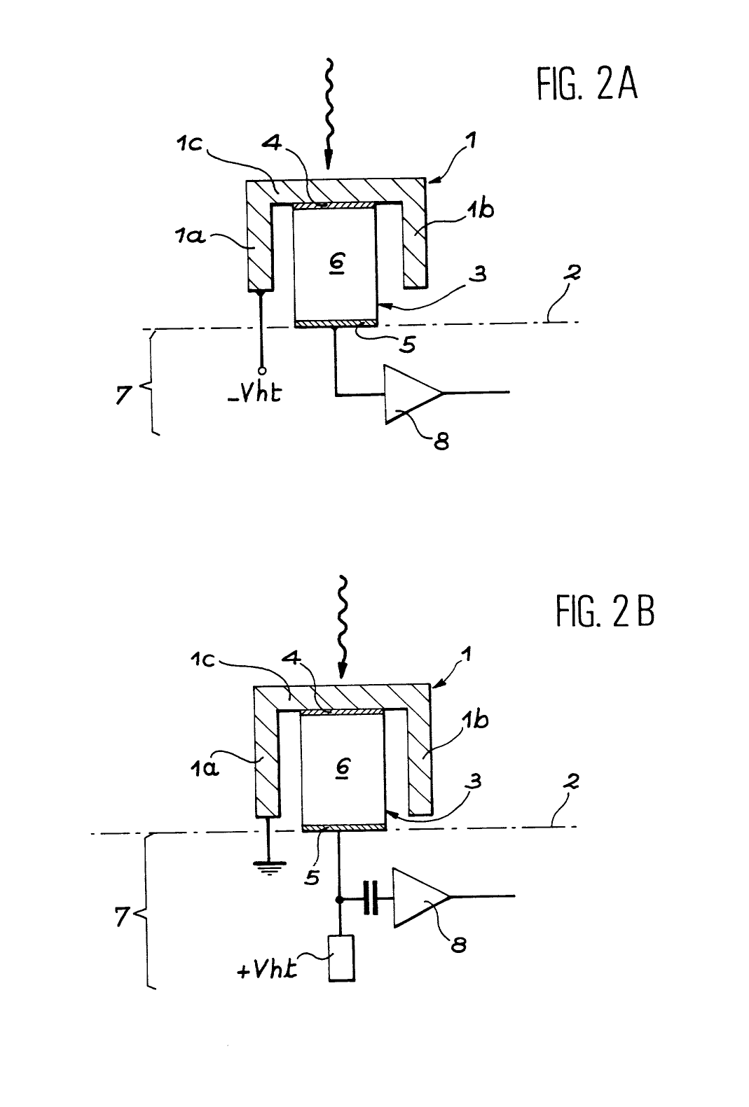

FIG. 1B shows the detector support device of FIG. 1A, in the case when walls 1a and 1b are mechanically connected in order to form a U. The electrical circuitry may be identical to that of FIG. 1A, but an insulation 9 between electrode 5 and base 1c of support 1 is then required. In this case, it is worth inverting the role of electrodes 4 and 5 and then rediscover the wiring which has just been described with reference to FIG. 2A.

In FIGS. 2A and 2B, the device of the invention is illustrated according to a second embodiment.

In FIGS. 2A and 2B, reference symbols identical to reference symbols of FIG. 1 represent identical components.

In this embodiment, the detector support 1 has the shape of a U the legs of which are the walls 1a and 1b of the detector support. This U-shaped detector support is placed, as a hood, above detector 3, the base of the U (referenced as 1c) directly lying on electrode 4.

Walls 1a and 1b are of the same length, the latter being less than or equal to the total height of detector 3. However the distance between the walls and the platforms may have any arbitrary value; there are no functional limits.

In this embodiment, electrodes 4 and 5 may be polarized in two different ways:

either electrode 4 is set to a negative high voltage (case of FIG. 2A), for example, via the detector support 1 supplied with a negative high voltage −Vht, and electrode 5 is connected to the electronic circuit 8;

either electrode 5 is set to a positive high voltage and electrode 4 is set to the ground (case of FIG. 2B); in this case, the positive high voltage is transferred onto the lower electrode 5 by the electronic circuit 7, whereas the detector support 1 is connected to the ground, thus transferring the ground potential to the electrode 4.

In the embodiment of these FIGS. 2A and 2B, base 1c of the detector support may be thinned, or else bored with holes, in order to facilitate transmission of incident radiation.

Regardless of the embodiment of the invention, each compartment may surround several detectors, i.e. several detection components each associated with an upper electrode and a lower electrode. Thus, several pixels may be obtained in a single device of the invention.

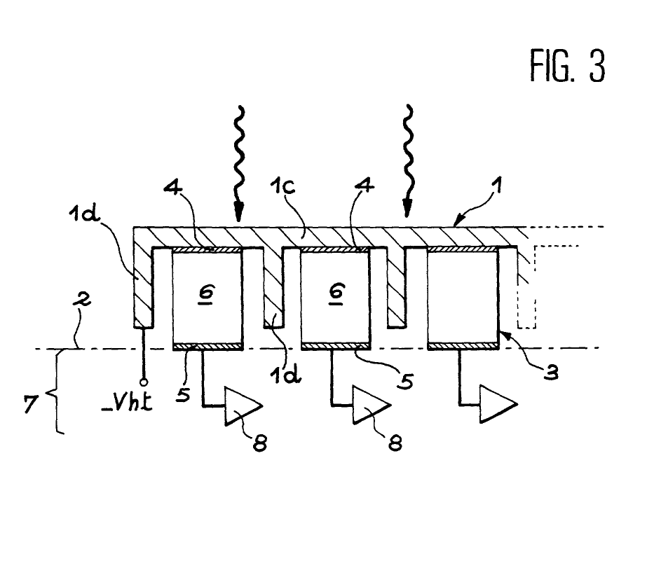

In FIG. 3, an application of the device of the invention is illustrated according to its embodiment of FIGS. 2A and 2B. In this application, several identical devices of the invention are associated with one another in order to form a detection linear array (if they are associated along a single dimension), or an imager (if they are associated along two dimensions).

In this application, the detector support is referenced as 1, which in this case includes several compartments separated by walls 1d.

These walls 1d are identical and have the same characteristics as walls 1a and 1b of the embodiments describes earlier.

In this embodiment, each detector 3 is identical to the detector 3 of FIGS. 2A and 2B and each lower electrode 5 is connected to a readout preamplifier 8 which, associated with other readout preamplifiers 8, forms the readout circuit.

Such a device is therefore able to receive several radiations simultaneously and to transform these radiations into several electrical signals detected by the readout circuit 7.

It is also understood that the detection device corresponding to the embodiment of FIGS. 1A and 1B may also be associated with other identical devices in order to form a matrix of detectors, in an identical way to that shown in FIG. 3.

1. A detection device for ionizing radiations comprising:
at least a detection component in semiconducting material (6), with upper and lower faces and a central portion, and providing conversion of ionizing radiations into electric charges;
an upper electrode (4) and a lower electrode (5) positioned on the upper face and the lower face of the detection component, respectively, facing each other;
a support (1) wherein the detection component is positioned; and
electronic means (7) for polarizing the electrodes and reading out the signals delivered by said electrodes,
characterized in that the support includes walls (1a, 1b, 1d) in a conducting material forming at least an open compartment, surrounding the detection component (6) without any electrical contact with the central portion of said detection component.

2. The device according to claim 1, characterized in that the support is U-shaped.

3. The device according to claim 1, characterized in that walls of the compartment are separated from the central portion of the detection component by an insulating material.

4. The device according to claim 2, characterized in that the compartment surrounds several detection components.

5. The device according to claim 1, characterized in that the compartment surrounds several detection components.

6. The device according to claim 2, characterized in that the compartment surrounds several detection components.

7. The device according to claim 3, characterized in that the compartment surrounds several detection components.

8. The device according to claim 4, characterized in that the compartment surrounds several detection components.

9. The device according to claim 1, characterized in that the support includes several compartments positioned one beside the other.

10. The device according to claim 2, characterized in that the support includes several compartments positioned one beside the other.

11. The device according to claim 3, characterized in that the support includes several compartments positioned one beside the other.

12. The device according to claim 4, characterized in that the support includes several compartments positioned one beside the other.

13. The device according to claim 5, characterized in that the support includes several compartments positioned one beside the other.

14. The device according to claim 6, characterized in that the support includes several compartments positioned one beside the other.

15. The device according to claim 7, characterized in that the support includes several compartments positioned one beside the other.

16. The device according to claim 8, characterized in that the support includes several compartments positioned one beside the other.

17. The device according to claim 1, characterized in that the walls of the support (1) are set to a fixed potential.

18. The device according to claim 2, characterized in that the walls of the support (1) are set to a fixed potential.

19. The device according to claim 3, characterized in that the walls of the support (1) are set to a fixed potential.

20. The device according to claim 5, characterized in that the walls of the support (1) are set to a fixed potential.
